(19) United States
(12) Patent Application Publication
(10) Pub. No.: US 2008/0234929 A1
(43) Pub. Date: Sep. 25, 2008

(54) SYSTEM AND METHOD TO DETERMINE, IN A VEHICLE, LOCATIONS OF INTEREST

(75) Inventors: David Leslie Watson, Ann Arbor, MI (US); Thomas Giuli, Ann Arbor, MI (US); Krishnaswamy Venkatesh Prasad, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/688,352

(22) Filed: Mar. 20, 2007

(51) Int. Cl. G01C 21/00

(52) U.S. Cl. 701/207; 701/200

(57) ABSTRACT

An occupant of a vehicle requests locations of interest from a remote provider. Locations of interest are identified based on the current location of the vehicle and a social network of the occupant. The locations of interest are provided to the vehicle via a network.

### BACKGROUND OF THE INVENTION

1. Field of the Invention

The invention relates to systems and methods to determine, in a vehicle, locations of interest.

2. Discussion

Internet-based social networking tools seem to be gaining popularity as people become increasingly interested in using technology to improve the quality of social interactions. These tools may be used to support communication between users. For example, users may share stories about a restaurant they visited or a trip they took including text and pictures.

Some web applications may be associating this type of information with physical locations, allowing users, for example, to find all pictures taken in a specific region of a map.

### SUMMARY

Embodiments of the invention may take the form of a method to determine locations of interest for an occupant of a vehicle. The method includes determining a current location of the vehicle, requesting locations of interest within a predefined geographic region, receiving at least one location of interest, and presenting the locations of interest to the occupant.

Embodiments of the invention may take the form of a system to determine locations of interest for an occupant of a vehicle. The system includes a location module configured to determine a current location of the vehicle. The system also includes a communication module configured to request locations of interest within a predefined geographic region and to receive at least one location of interest. The system further includes a display module configured to present locations of interest to the occupant.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is an illustration of a circle of friends and shows the interconnected relationships of the members of the circle of friends.

FIG. 2 is a block diagram of a vehicle, network, and information sources in accordance with an embodiment of the invention and shows the vehicle and information sources communicating via the network.

FIG. 3A is an illustration of the vehicle of FIG. 2 within a geographic region and shows points of interest inside and outside the geographic region.

FIG. 3B is another illustration of the vehicle of FIG. 2 within the geographic region and shows points of interest, inside the geographic region, identified by members of the circle of friends and a point of interest not identified by members of the circle of friends.

FIG. 4A is a table of information concerning points of interest populated by various circles of friends and includes the name and location of each point of interest and the respective member who identified each point of interest.

FIG. 4B is a table of information concerning points of interest identified by the circle of friends of FIG. 1 and falling within the geographic region of FIGS. 3A and 3B.

FIG. 5A is the table of information concerning points of interest of FIG. 4B and shows the information sorted by member.

FIG. 5B is the table of information concerning points of interest of FIG. 4B and shows the information sorted by rating.

FIG. 5C is the table of information concerning points of interest of FIG. 4B and shows the information sorted by age.

FIG. 5D is the table of information concerning points of interest of FIG. 4B and shows the information sorted by frequency.

### DETAILED DESCRIPTION

Social facilitation tools are relatively unusable in the context of an automobile. An existing web based interface requires too much attention to be usable by a person driving a vehicle. At the same time, the actual location of the vehicle provides additional context to the information a person would be interested in receiving from one of these tools.

Some embodiments of the invention provide information from an occupant's social network based on the current location of the occupant's vehicle. The vehicle may determine its current location by using an existing GPS sensor which may be part of an on-board navigation system. Additionally, the current location may be determined using a GPS sensor from a portable navigation device, a cell-based location service based on cellular phone signals, or any other similar technique.

Some embodiments of the invention query a database to match the filtered list of nearby points of interest with information related to those points of interest from the occupant's social network. The database may contain social network information and geocoded points of interest. Relevant pieces of information may include a list of points of interest with names attached that can be mapped back to a social network. This would indicate, for example, that a particular restaurant was discussed by a friend of a friend. Additionally, rating information associated with the point of interest may provide additional input. This information may be gathered when needed using, for example, an internet connection in the car, or it could be pre-fetched as part of some type of trip planning step and cached in the vehicle.

Some embodiments of the invention gather points of interest that are close to the current location from a points of interest database or web service, if available. This may use an existing built-in navigation system which contains a database of points of interest as well as an algorithm to filter the database based on the current location. Alternatively, the list of proximate points may come from a web service using an internet connection in the car. The data may also be pre-calculated for a pre-determined trip and manually transferred to the car using a portable storage device such as a USB memory stick or portable music player.

In some cases, the points of interest list may be pre-filtered to match specific requests from the driver or passengers. For example, the driver may request information about local restaurants, in which case the point of interest query would include this filter to limit the results.

Some embodiments of the invention combine the two sets of points of interest information into one list. This operation may be implemented as a simple set addition. Other algorithms, e.g., set intersection, may also be used depending on the relative completeness of the data.

Some embodiments of the invention rank a resulting list of points of information based on the social networking information. This may take into account both the social rank of the person associated with a point of interest, the ranking of that point of interest, and any preference information available about the occupant and the people in the social network.

Ranking algorithms may be implemented as a simple sort based on rating information, degree of separation to the related person, number of references, or any other similar criteria. Alternatively, ranking may use a preference matching algorithm to recommend various points of interest. These ranking algorithms may result in a sorted list of points of interest in which higher ranked entries are intended to be more useful to the driver or passengers in the car.

Ranking may be performed in the vehicle on a built-in navigation system or other computer within the vehicle. Alternatively, ranking may be performed on an internet server and transferred to the vehicle either on demand, or pre-computed and cached as discussed above.

Some embodiments of the invention present sorted list of points of interest to the driver or passengers of the vehicle. This may be implemented as part of a built-in navigation system where the sorted list of points of interest is shown on the screen in their correct geographical location. This information may also allow the driver an additional choice when searching for points of interest. For example, rather than just searching for points of interest that are close, the driver may search for points of interest that are close and that are also rated highly by the social network. This list of points of interest may be presented using another human-machine interface such as a radio screen or a voice prompt.

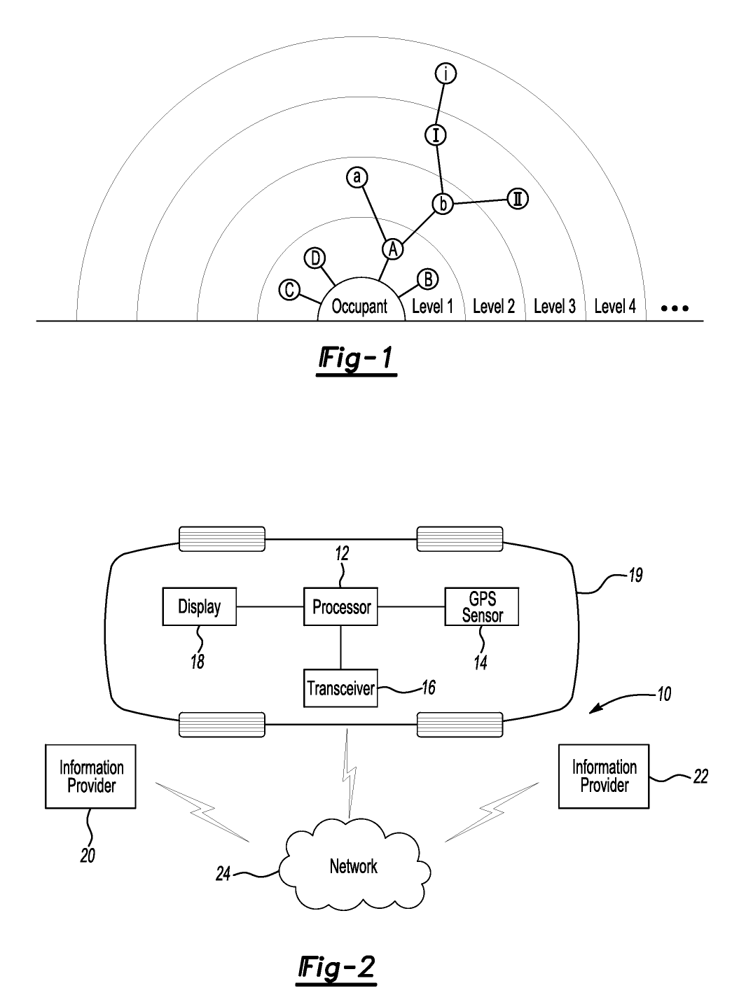

FIG. 1 is an illustration of a circle of friends for Occupant. Occupant is shown with four friends A, B, C, and D. A is shown with two friends a and b. b is shown with two friends I and II. I is shown with a single friend i. Relative to Occupant, A, B, C, and D occupy level one, a and b occupy level two, I and II occupy level three, and i occupies level four. These levels indicate the closeness of the relationship between Occupant and the members of his circle of friends.

Members occupying lower-numbered levels are closer to Occupant than those members occupying higher-numbered levels. Thus, Occupant may know A, but may have never met i. Those members that occupy level one are friends with Occupant whereas those members that occupy level two are friends with at least one member of the immediate lower level. For example, A is friends with Occupant, b is friends with A but not necessarily friends with Occupant, I is friends with b but not necessarily friends with A or Occupant, and i is friends with I but not necessarily friends with b, A, or Occupant.

A similar circle of friends could be constructed for any of the members shown in FIG. 1. For example, b could be at the center of the circle of friends. A, I, and II would occupy b's level one and a, i, and Occupant would occupy b's level two.

As described below, circles of friends can be used to assist Occupant in making decisions as to, for example, which restaurant or bar in his vicinity to visit.

FIG. 2 is a block diagram of system 10. System 10 includes processor 12, GPS sensor 14, transceiver 16, and display 18 of vehicle 19. GPS sensor 14, transceiver 16, and display 18 communicate via hard wire with processor 12. In alternative embodiments, one or more of GPS sensor 14, transceiver 16, and display 18 may communicate with processor 12 via a car area network (not shown). Processor 12 communicates with information providers 20, 22 via transceiver 16 and network 24. Transceiver 16 is configured to send wireless signals to and receive wireless signals from information providers 20, 22 via network 24.

Occupant may be interested in learning of points of interest in the vicinity of vehicle 19 that have been visited by members of the circle of friends of Occupant. Occupant may request such information from information provider 20 which keeps and provides point of interest information identified by members of various circles of friends.

Information provider 20 offers a service, to which Occupant and his circle of friends subscribe, that keeps circle of friend information, such as that illustrated in FIG. 1, and permits Occupant and his circle of friends to submit information concerning points of interest, e.g., restaurants, clubs, etc., via for example, text message, email, or other communications medium.

Processor 12 and GPS sensor 14 cooperate to determine, in conventional fashion, the coordinate data for the current location of vehicle 19. Processor 12 then defines region 26 around the current location of vehicle 12 and communicates information concerning region 26 to information providers 20, 22.

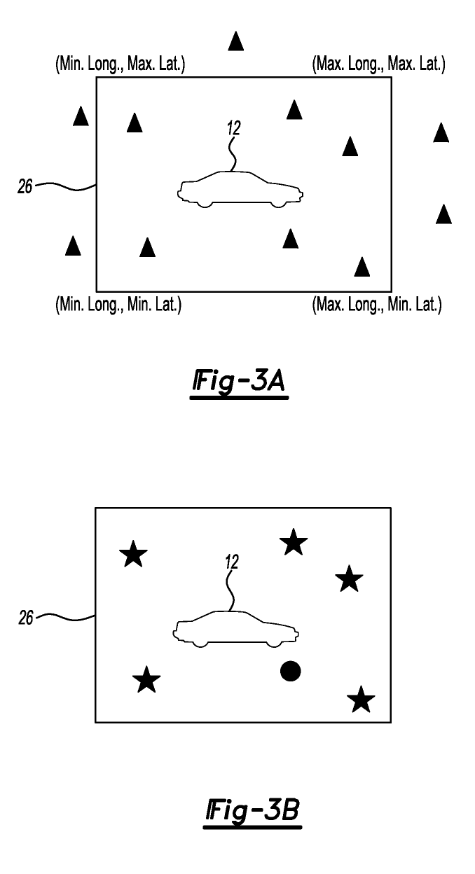

FIG. 3A is an illustration of vehicle 19 within region 26 and shows points of interest inside and outside region 26. In the embodiment of FIG. 3A, region 26 is defined by a set of minimum and maximum longitude and latitude coordinates. Processor 12 determines these coordinates based on the current location of vehicle 12. For example, if vehicle 12 is currently at location (5,5), processor 12 will add and subtract a predefined coordinate distance, e.g., five units, to the current location of vehicle 12:

Minimum longitude=center location longitude−randomized selection.

Maximum longitude=center location longitude+randomized selection.

Minimum latitude=center location latitude−randomized selection.

Maximum latitude=center location latitude+randomized selection.

As such, the set of coordinates defining region 26 are (0,0), (10,0), (10,10), and (0,10).

Information providers 20, 22 use region 26 to determine which points of interest, represented by triangles, are within region 26 of vehicle 12.

In alternative embodiments, vehicle 19 may communicate its current location to information providers 20, 22 and information providers 20, 22 may generate region 26 as described above.

FIG. 3B is another illustration of vehicle 19 within region 26. The stars indicate points of interest falling within region 26 and identified by members of the circle of friends of Occupant. The circle indicates a point of interest falling within region 26 and not identified by members of the circle of friends of Occupant. Information concerning the former points of interest will be sent to vehicle 19 via network 24 (FIG. 2) in response to a request from Occupant concerning points of interest in the vicinity of vehicle 19 that have been visited by members of the circle of friends of Occupant.

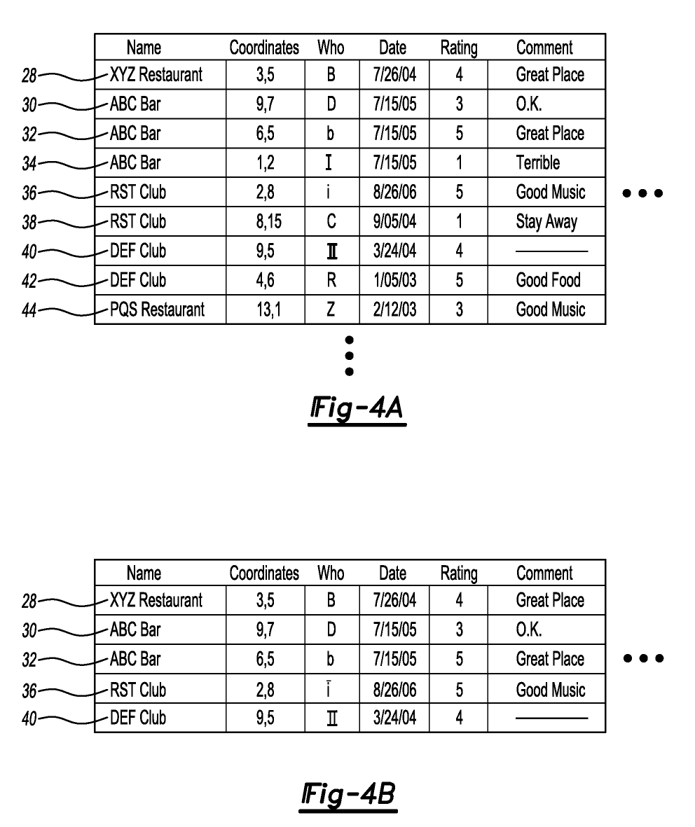

FIG. 4A is a table of information concerning points of interest. As described above, information provider 20 may keep and provide portions of such data upon request. Information in data records 28, 30, 32, 34, 36, 38, 40, 42, 44 are provided by members of various circles of friends that subscribe to the services offered by information provider 20. Data records 28, 30, 32, 34, 36, 38, 40, 42, 44 include name, coordinate, who, date, rating, and comment information regarding points of interest. Information provider 20 uses data records 28, 30, 32, 34, 36, 38, 40, 42, 44 in combination with region 26 and circle of friend information, such as that illustrated in FIG. 1, to select and provide point of interest information to Occupant.

FIG. 4B is a table of information concerning points of interest for Occupant falling within region 26. This information includes points of interest identified by all four levels of the circle of friends of Occupant. In alternative embodiments, Occupant may limit the level, e.g., level two, from which Occupant receives information concerning points of interest.

The information of FIG. 4B is sent to Occupant via network 24 (FIG. 2). Processor 12 (FIG. 2) may then sort the information by name, coordinate, who, date, etc.

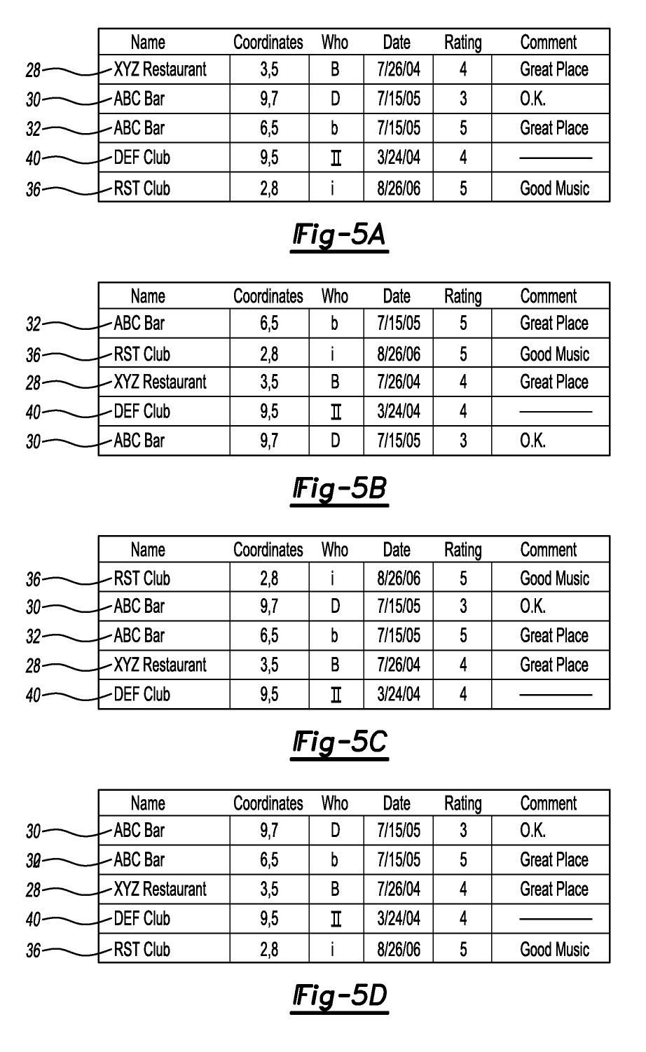

FIG. 5A is the table of information concerning points of interest of FIG. 4B showing the information sorted by the level of the member who identified it. Points of interest identified by members of level one of Occupant are higher than points of interest identified by members of levels higher than level one.

FIG. 5B is the table of information concerning points of interest of FIG. 4B showing the information sorted by rating. Points of interest with the highest rating are higher than points of interest with lower ratings.

FIG. 5C is the table of information concerning points of interest of FIG. 4B showing the information sorted by age. Points of interest identified more recently are higher than points of interest identified earlier.

FIG. 5D is the table of information concerning points of interest of FIG. 4B showing the information sorted by frequency. Points of interest visited by the most members of the circle of friends of Occupant are higher than points of interest visited by fewer members of the circle of friends of Occupant.

In alternative embodiments, Occupant may submit such sorting information described above to information provider 20. Information provider may then sort the point of interest information prior to providing it.

The information, in any form such as that of FIGS. 4B-5D, is then presented to Occupant via display 18.

In a manner similar to that described above, Occupant may also request point of interest information not identified by members of the circle of friends of Occupant from, for example, information provider 22. Region 26 information may be used to determine which points of interest are in the vicinity of vehicle 19. This point of interest information, when received by vehicle 19, may be combined with the point of interest information identified by the circle of friends of Occupant, e.g., appended at the bottom of the point of information of any of FIGS. 5A-5D. This combined information may then be presented to Occupant via display 18.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method to determine locations of interest for an occupant of a vehicle, the method comprising:
determining a current location of the vehicle;
requesting, from a remote provider, locations of interest within a predefined geographic region based on the current location of the vehicle;
receiving, from the remote provider, at least one location of interest wherein the at least one location of interest has, associated with it, information provided by a member of a social network of the occupant;
ranking the at least one location of interest based on predefined criteria associated with the social network of the occupant; and
presenting the ranked locations of interest to the occupant.

2. The method of claim 1 wherein the predefined criteria comprises a social rank of the at least one member of the social network.

3. The method of claim 1 wherein the predefined criteria comprises a member rating.

4. The method of claim 1 wherein the predefined criteria comprises a number of members associated a location of interest.

5. The method of claim 1 wherein the predefined criteria comprises an age of the information.

6. The method of claim 1 wherein the information includes a member rating.

7. The method of claim 1 wherein the information includes a date.

8. A method to determine locations of interest for an occupant of a vehicle, the method comprising:
determining a current location of the vehicle;
requesting, from a remote provider, locations of interest within a predefined geographic region based on the current location of the vehicle wherein the request includes predefined criteria associated with a social network of the occupant;
receiving, from the remote provider, at least one location of interest ranked according to the predefined criteria wherein the at least one location of interest has, associated with it, information provided by a member of the social network of the occupant; and
presenting the ranked locations of interest to the occupant.

9. The method of claim 8 wherein the predefined criteria comprises a social rank of the at least one member of the social network.

10. The method of claim 8 wherein the predefined criteria comprises a member rating.

11. The method of claim 8 wherein the predefined criteria comprises a number of members associated a location of interest.

12. The method of claim 8 wherein the predefined criteria comprises an age of the information.

13. The method of claim 8 wherein the information includes a member rating.

14. The method of claim 8 wherein the information includes a date.

15. A system to determine locations of interest for an occupant of a vehicle, the system comprising:
a location module configured to determine a current location of the vehicle;
a communication module configured to request, from a remote provider, locations of interest within a predefined geographic region based on the current location of the vehicle and receive, from the remote provider, at least one location of interest wherein the at least one location of interest has, associated with it, information provided by a member of a social network of the occupant; and
a display module configured to present locations of interest to the occupant.

16. The system of claim 15 further comprising a processing module to rank the at least one location of interest based on predefined criteria associated with the social network of the occupant.

17. The system of claim 15 wherein the predefined criteria comprises a social rank of the at least one member of the social network.

18. The system of claim 15 wherein the predefined criteria comprises a member rating.

19. The system of claim 15 wherein the predefined criteria comprises a number of members associated a location of interest.

20. The system of claim 15 wherein the predefined criteria comprises an age of the information.
